(19) United States
(12) Patent Application Publication
(10) Pub. No.: US 2007/0186684 A1
(43) Pub. Date: Aug. 16, 2007

(54) Vibrating tube mass flow meter

(76) Inventor: Nghieu Q. Pham, (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 10/565,915

(22) PCT Filed: Jul. 26, 2004
(86) PCT No.: PCT/US04/23941

§ 371 Date: Jan. 24, 2006

Related U.S. Application Data
(60) Provisional application No. 60/490,368, filed on Jul. 24, 2003.

(51) Int. Cl. G01F 1/84

(52) U.S. Cl. 73/861.357

(57) ABSTRACT

A vibrating tube meter measures the density, mass flow rate or viscosity of a fluid material including a vibration section. An exciter induces vibrations in the tube vibration section at a resonance frequency. A motion sensor detects motion of the tube from the induced vibrations. A helical coil spring has opposing ends coupled to the tube with the tube positioned within the interior of the coil spring. An external housing is rigidly coupled to the tube inlet end and outlet end and has a mass selected to provide a suitable nodal mass for the tube vibration section and spring element. Temperature sensors are coupled to the tube, the spring element and the external housing. A pressure sensor is coupled to the tube. A processor includes a drive amplifier and a novel adaptive filter and processes signals form the sensors. A novel viscosity integrator processes signals from the motion sensors, temperature sensors and the pressure sensor to accurately calculate density, mass flow rate and viscosity of the fluid material as well as percent concentration of a solute in the fluid material.

### RELATED APPLICATION DATA

This application is based on and claims the benefit of U.S. Provisional Patent Application No. 60/490,368 filed on Jul. 24, 2003, the disclosure of which is incorporated herein by this reference.

### BACKGROUND

This invention relates to direct mass flowmeters. More particularly, it concerns mass flowmeters of the vibrating tube type.

For some time, vibrating tube mass densitometers and mass flowmeters have been routinely used to directly measure mass and mass flow rate characteristics of fluids. Mass flowmeters (or direct mass flowmeters) have sensing means that respond uniquely to mass flow rate. Other flowmeters employ, for example, sensing means that respond to differential pressure or fluid velocity. If one needs to measure mass flow rate with such devices one must perform separate measurement of density and infer some flow distribution pattern in the cross section of the meter and also infer fluid flow pattern, such as turbulence. They also require Newtonian fluid behavior, which is often not met. Thus for reason of measurement simplicity alone, the direct mass flowmeters are very desirable. Other flowmeters generally lend themselves much better to volume flow rate measurement than to mass flow measurement. In practice, the mass flow measurement is much more useful because chemical reactions require blending of proportional mass rather than volume of ingredients and product specifications mostly refer to mass percentage of ingredients not volume percentage. This represents another major advantage of direct mass flow measurement over other techniques.

Most vibrating tube mass flowmeters operate by using the principle of the Coriolis effect. One type employs a substantially straight vibrating tube, the other a curved or looped vibrating tube. Additionally, there are mass flowmeters with one vibrating tube and there are mass flowmeters with two vibrating tubes. Those mass flowmeters utilizing two tubes permit either parallel or series flow of the fluid through the meter. In recent times, vibrating tube meters employing only one essentially straight vibrating tube have become more popular in the industry. Compared to mass flowmeters using either two straight measuring tubes or one looped measuring tube, vibrating tube type mass flowmeters with only one straight measuring tube offer significant advantages. The primary advantage that single tube mass flowmeters hold over mass flowmeters with two measuring tubes is that the single tube designs do not require a flow divider or flow combiner, the presence of which adds cost to the device, disturbs the flow of the fluid within the tube, and complicates the measurement process. Compared to single or dual looped vibrating tube devices, the main advantages of the straight vibrating tube design are that it is easier to manufacture than the looped or curved versions, there is less fluid pressure drop in a straight tube than in a looped tube, and a straight tube is easier to clean than a looped tube.

Vibrating tube flowmeters are often referred to as Coriolis-effect flowmeters or Coriolis flowmeters, and are direct mass flowmeters. Single-tube meters employ the well-known principle of the effect of Coriolis forces on the tube as it vibrates and use the influence of a pattern of such forces upon the tube as it carries the fluid for which the mass flow measurement is sought. The tube is typically part of a vibrating assembly in a Coriolis mass flowmeter. The assembly has a set of natural vibration modes, which may be of a simple bending, a torsional, a radial or a coupled type. These naturally resonant vibration modes are largely a function of the characteristics of the vibrating tube and its contents, as is well known in the art. Each tube is driven to oscillate at resonance in one of these natural modes. Fluid flows into the flowmeter tube's inlet and exits the flowmeter tube's outlet. The natural vibration modes of the vibrating, fluid-filled system are predominantly defined by the combined mass and stiffness characteristics of the tube material and the fluid flowing within the tube. A drive excitation force is typically applied to the tube near the center of the tube. This excitation force is commonly sinusoidal in nature. When there is no flow through the flowmeter, all points along the tube oscillate in response to the applied excitation force. The frequency of this oscillation is inversely proportional to the mass of the fluid contained within the tube. All points along the tube oscillate with zero change in phase difference. When fluid flows through the tube, Coriolis forces cause a change in phase difference with respect to the static condition, which occurs between the center of the tube and each tube end. The phase on the inlet side of the tube lags the driver, while the phase on the outlet side leads the driver. Sensors are placed on the tube to produce sinusoidal signals representative of the motion of the tube. The sensor output signals are processed to determine the change in phase difference between the sensor locations along the tube. The change in phase difference between two sensor output signals is proportional to the mass flow rate of fluid flowing through the tube. Vibrating tube flowmeters operating substantially as described above have become widely used with great success.

Still, this successful utilization notwithstanding, vibrating tube mass flowmeters with one straight vibrating tube possess a variety of limitations in performance and accuracy. For example, thermal expansion and stress during operation of the meter cause variations in the measuring accuracy in a straight vibrating tube mass flowmeter. Vibration-dependent characteristics such as the length and elasticity of the vibrating assembly vary as a function of the temperature of the tube as well as the temperature of the fluid within the tube. The temperature-dependent changes introduce variables into the system resulting in measurement inaccuracies. In extreme cases, thermal stress can lead to mechanical defects such as stress-induced cracks in the measuring tube. Several attempts to compensate for the effects of temperature in vibrating tube flowmeters have been applied in prior art. One such attempt involves the presence of solid isolation bars substantially parallel to the flow tube and rigidly coupled to the ends of the tube. In another temperature-compensating scheme, a compensating cylinder is rigidly coupled&to the ends of the tube, the tube being located along the longitudinal axis of the cylinder. In still another device, a shell surrounds the tube and is coupled to the ends of the flow tube using diaphragms. Yet another technique utilizes length-variation sensors to detect changes in the tube length and to provide this data for correcting the length-dependent, vibration-related measurement. These attempts to mitigate temperature-related variation of vibrating tube mass flowmeters have met with limited success.

Another drawback of vibrating tube mass flow meters results from changes in fluid pressure during operation of the flow meter. Fluid pressure change modifies the cross-sectional dimension of the flow tube thereby changing the flow tube's bending properties. Large pressure changes that can occur in practice will jeopardize measurement accuracy.

In addition to the effects of temperature and pressure on the flowmeter performance during operation, uncompensated variations in the elasticity of the tube are often introduced during the assembly process. In many cases, the tube is secured to the remainder of the flowmeter assembly using a heating process. Processes such as brazing or welding the tube introduce localized heating to the tube and the tube often becomes annealed or softened in the heat-affected regions. This annealing causes non-uniformity in the elasticity of the tube, degrades mechanical quality factor (Q) of the tube material, which in turn weakens the tube frequency of resonance, and causes instability in fluid parameter measurements.

Acoustic waves generated by pumps and other process equipment also can cause considerable deterioration of vibrating tube flowmeter measurements. Frequent transient, random acoustic disturbances often cause similar problems. The flowmeter may lose the ability to distinguish between forces induced by motion resulting from such disturbance from the Coriolis forces resulting from a flow rate change. The amplitude of the sensor output signal is often distorted by such outside disturbances to the point that the signal cannot be measured accurately using previously known techniques. In some aerospace applications, for example, the use of single straight tube Coriolis effect type mass flowmeters is made virtually impossible due to surrounding vibrations, especially when the aircraft vibration amplitude approaches a 20 G force, and the frequency exceeds about 1000 Hz. Vibrations encountered during airplane take-off and landings are of such magnitude and spectral content that they totally mask the vibrations related to the natural frequency of the tube and its fluid contents and related to the mass flow rate.

Another problem for vibrating tube flowmeters is entrainment of gases in the fluid. The gas may be in the form of visible or microscopic size bubbles. Gas entrainment causes both fluid density change and change in the coupling between the fluid and the wall of the measurement tube. This coupling is essential for the Coriolis-effect type flowmeter. Generally, state-of-the-art vibrating tube flowmeters exhibit significant to intolerable errors in measurement accuracy when the gas entrainment reaches a level of 1% to 3% volume ratio of gas to fluid. One particular example where gas entrainment causes a problem is in the semiconductor industry. A slurry of nitric acid, silicon, and other materials is used to polish semiconductor wafers in a critical step in the manufacturing process. Hydrogen peroxide is mixed with the slurry in a critical concentration by mass ratio to control the pH of the mixture. The concentration is measured using an elaborate system of valves and pump, uses an expensive, large titration process, and requires high maintenance. Concentration can be readily measured using a mass flowmeter except that the hydrogen peroxide is very prone to out gas resulting in entrained gases in sufficient amounts to render vibrating tube flowmeters useless.

Attempts are ongoing that strive to reduce the effects of undesirable tube vibration resulting from outside acoustical resonances and process vibrations due to other influences as well as from those induced by entrained gases. They include various isolation shock absorber schemes that attempt to isolate the tube from external forces. More recently, electronic signal processing has been introduced in an attempt to control the vibration of the tube. Filtering and drive control circuitry have been added within the sensor/drive amplifier/excitation loop to detect unwanted modes of vibration and to negate them within the composition of the signal that excites the tube. These implementations are complex and have, to date, had little success. Additionally, they are unpredictable and not responsive to the problems caused by gases entrained within the fluid in the tube.

In many applications, vibrating tube mass flowmeters are used in concert with other measurement devices to provide a multiplicity of information about fluid properties. These include, among others, mass, mass flow rate, volume flow rate, temperature, pressure, viscosity and concentration. The use of a multitude of varying types of meters presents problems in measurement accuracy and compatibility, equipment maintenance and calibration, and capital and operating expenditures.

In view of the above discussion, there exists a need for a vibrating tube mass flowmeter that accurately measures mass flow over a wide range of operating temperatures. Accordingly, it is an object of the present invention to provide such an energy mass flowmeter.

It is another object of the invention to provide a system and method to reduce the undesirable effects of localized heating of the flow tube during the assembly process.

Still another object of the present invention is to provide a vibrating tube mass flowmeter that is accurate despite changes in pressure of the fluid within the tube.

It is yet another object of the invention to provide a vibrating tube mass flowmeter that operates with great accuracy in the presence of undesirable acoustic and similarly generated interference.

Another object of the invention is to provide for a mass flowmeter that operates with great accuracy when the fluid within the flowmeter contains entrained gases.

Still another object of the invention is to provide a signal processing apparatus and technique that filters unwanted noise and the intrusion of external resonant spikes from the measured signal within the flow meter, providing for improved accuracy of direct mass flow, density and viscosity measurements.

Further, it is an object of the invention to provide a multivariable energy mass flow meter that accurately and instantaneously provides measurements including but not limited to fluid density, flow rate, mass flow rate, temperature, pressure, concentration, and viscosity.

It is yet another object of the invention is to provide an energy mass flowmeter that directly measures mass flow in harsh environments such as aircraft flight, particularly during take-off and landing scenarios.

Additional objects and advantages of the invention will be set forth in the description that follows, and in part will be apparent from the description, or may be learned by practice of the invention. The objects and advantages of the invention may be realized and obtained by the instrumentalities and combinations pointed out herein.

### SUMMARY

To achieve the foregoing objects, and in accordance with the purposes of the invention as embodied and broadly described in this document, there is provided a vibrating tube meter for measuring the density, mass flow rate or viscosity of a fluid material. The meter includes a hollow tube having an inlet end and an outlet end and including a vibration section. An exciter induces vibrations in the tube vibration section at a resonance frequency. A motion sensor detects motion of the tube from the induced vibrations. A spring element is coupled to the tube vibration section between a first end and a second end.

In one advantageous embodiment, the spring element comprises a helical coil spring having opposing ends coupled to the tube with at least a portion of the tube positioned within the interior of the coil spring. The vibration section of the tube is generally aligned along a tube longitudinal axis and the spring element has a longitudinal axis oriented generally along the tube longitudinal axis. The vibration section of the tube is generally straight. An external housing is rigidly coupled to the tube inlet end and outlet end and has a mass selected to provide a suitable nodal mass for the tube vibration section and spring element. The spring element can be selected to have a spring load constant to isolate the vibration section from vibrations external to the vibration section and spring. A first isolation member is attached to the tube near one end of the vibration section and a second isolation member is attached to the tube near another end of the vibration section. The spring element first end is attached to the first isolation member, and the spring element second end is attached to the second isolation member. Preferably, the isolation members comprise flanges that are brazed to the tube, the spring element first end is welded to the first isolation member and the spring second end is welded to the second isolation member. The tube vibration section and the spring element are selected to have coefficients of thermal expansion that generally match. Temperature sensors can be coupled to the tube to sense the temperature of the tube, to the spring element to sense the temperature of the spring element, and to the external housing element to sense the temperature of the external housing. A pressure sensor can be coupled to the tube to sense the pressure of fluid material in the tube. A processor includes a drive amplifier and a novel adaptive filter. A novel a viscosity integrator processes signals from the motion sensors, temperature sensors and the pressure sensor to accurately calculate density, mass flow rate and viscosity of the fluid material as well as percent concentration of a solute in the fluid material.

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a front elevation in partial cross-section of one embodiment of a mass flow meter according to the present invention, showing the processor in functional block diagram.

FIG. 2 is a front elevation in partial cross-section of a second embodiment of a mass flow meter according to the invention, shown without the processor.

FIG. 3 is a logical flow diagram of an adaptive filter included in the processor of a flow meter according to the present invention.

FIG. 4 is a front elevation in partial cross-section of a composite mass flow meter according to the invention, shown without the processor.

FIG. 5 is a front elevation in partial cross-section of another embodiment of a flow meter according to the invention for use in small spaces, shown without the processor.

### DESCRIPTION

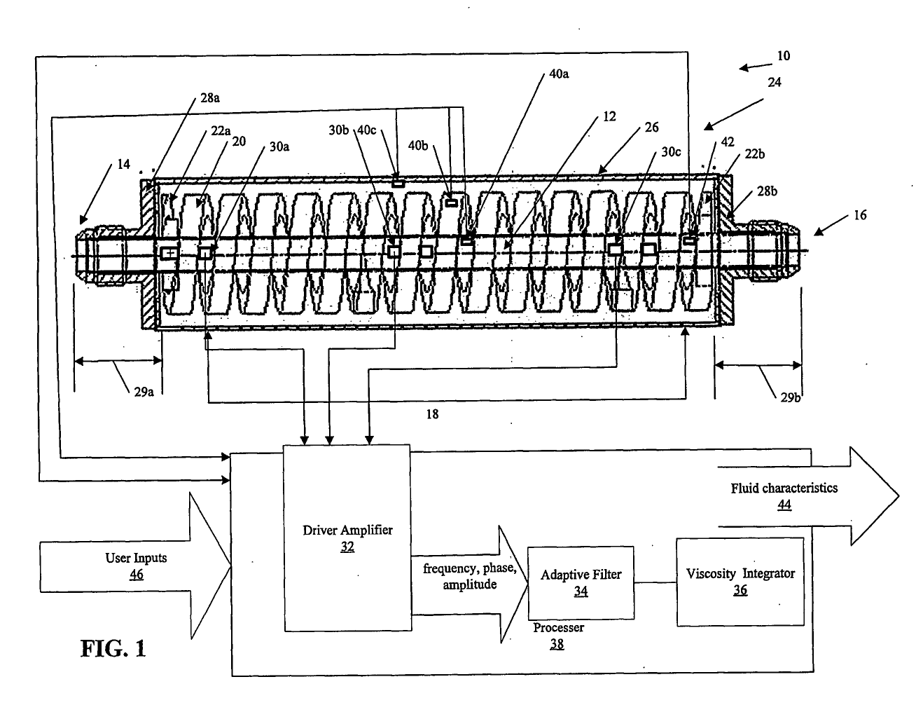

One presently preferred embodiment of a vibrating tube mass flow meter 10 in accordance with the present invention is depicted in FIG. 1. The flow meter 10 includes a hollow tube 12, the tube 12 having an inlet end 14 and outlet end 16 and a generally straight section 18. A spring element 20 having a first end and a second end is rigidly coupled to the straight section 18 of the tube 12 by way of isolation members 22a and 22b. The first isolation member 22a is attached to the spring element 20 first end, the second isolation member 22b is attached to spring element 20 second end, and both isolation members 22a and 22b are attached to the tube 12. An external housing 24 encloses the tube 12, the spring element 20, and the isolation members 22a and 22b, and is rigidly coupled to the tube inlet end 14 and outlet end 16. The spring element 20 comprises a helical coil having a longitudinal axis that is aligned generally along the longitudinal axis of the straight section 18 of the tube 12.

The tube 12, spring element 20, and the isolation members 22a and 22b combine to form a structure with a natural resonant frequency. The external housing 24 is of sufficient mass and rigidity so as to provide a nodal mass element for the resonant structure. In the presently preferred embodiment of the invention depicted in FIG. 1, the external housing 24 comprises a housing body 26 and two end caps 28a and 28b and is produced from stainless steel, as is common in the art. The end caps 28a and 28b of this presently preferred embodiment are manufactured to provide a fluid interface (i.e.—a flange) for fluid communication between other devices and the tube 12. One of ordinary skill in the art could envision a variety of materials sand configurations that would likewise provide a suitable nodal mass element for the resonant structure. The tube diameter, lengths and wall thickness and the tube material are selected in accordance with criteria normally considered in the design of a Coriolis mass flow meter. The tube 12 of one presently preferred embodiment is manufactured form stainless steel, but a variety of other suitable materials including hastelloy, nickel, tantalum, monel and titanium could also be used.

The inclusion of the of the spring element 20 as a stress relief medium in the resonant structure of the flow meter 10 of the present invention provides several benefits to the meter. First, the spring element 20 acts as an isolator during the flowmeter assembly process to reduce the undesirable effects of localized heating of the tube 12 during assembly. Assembly of the resonant structure of the flowmeter 10 and its rigid coupling with the external housing 24 preferably is accomplished by brazing the spring element 20 first end to the first isolation member 22a, brazing the spring element 20 second end to the second end isolation member 22b, welding the first end isolation member 22a to a region in proximity to a first end of the straight section 18 of the tube 12, and welding the second end isolation member 22b to a region in proximity to a second end of the straight section 18 of the tube 12. During the welding of the isolation members 22a and 22b to the tube 12, the spring element 20 functions to reduce the localized heating of the tube 10 by acting as a heat sink to transfer heat away from the weld zones and by providing an instant compensating force that counteracts the expansion and contraction of the tube 10 due to the thermal effects of the welding. It should be noted that-in the embodiment of the invention as shown in FIG. 1, the housing end caps 28a and 28b are structured such that there are free movement zones 29a and 29b of significant length present within housing end caps 28a and 28b. These free movement zones are produced by welding the tube 12 to the housing end caps 28a and 28b a significant distance (the length of the free movement zone) from the isolation members 22a and 22b. These free movement zones 29a and 29b reduce the effects of external resonance of the flowmeter 10. The use of free movement zones is well known and commonly practiced in the art.

The free expansion and contraction of the spring element 20 similarly isolate the tube from expansion and contraction due to any heating when the tube 12 is rigidly coupled to the external housing 24, as is present during the welding, or excessive welding, of the tube 12 to the external housing 24 in the presently preferred embodiments of the invention. Thus, undesirable effects such as the localized annealing of the tube 12 and the introduction of stored stresses into the tube 12 are mitigated. In a presently preferred embodiment, the spring element 22 is produced from spring steel, but a variety of other materials known in the art may be utilized, such as titanium, hastelloy, nickel, tantalum, or monel. The material from which the spring element 22 is produced may be selected using specific design criteria, such that the coefficient of thermal expansion of the spring element 22 reacts in a desired manner with the coefficient of thermal expansion of the tube 12 to minimize the thermal effects on the tube 12 during assembly and operation. Ideally, the material for the spring should match that of the vibrating tube material for best performance due to their identical thermal coefficients of expansion. During the operation of the flowmeter 10, the counteracting force of the spring element 20 reduces changes in the characteristics of the tube 12 that are due to temperature changes of the tube and the fluid within the tube 12, such as changes in elasticity, diameter, and length, to name a few.

Another function of the spring element 20 is to provide for a higher quality factor, or Q, of the resonant structure. Spring parameters such as load constant and length may be chosen to provide a more selective resonant structure, i.e. a resonant structure with a higher Q. By increasing the Q of the resonant structure, the spring isolates the structure, and hence the tube 12, from external perturbations such as factory equipment noise, floor vibrations, acoustic impulses, and the like. Testing of this concept has shown a significant reduction in the sensitivity of the meter 10 to external vibration over that of the prior art.

In addition, by selecting a spring element 20 to have an appropriate spring constant and by exciting the spring element 20, such as by a piezoelectric sensor, using an active vibration modeling protocol, the spring element 20 can be used to counter noise and external vibration and to reduce the impact of these on the accuracy of the meter 10. As will be apparent to one of ordinary skill in the art, configuration other than a helical coil spring could be used to implement the spring element 20 of the present invention. For example, a leaf spring or a pair of leaf springs may be used for spring element 20.

Referring again to FIG. 1, the flow meter 10 also includes a processor 38 comprising a drive amplifier 32, an adaptive filter 34 and a viscosity integrator 36. Transducers 30a, 30b, and 30c are coupled to the straight section 18 of the tube 12. Two transducers 30a and 30c are electrically coupled to inputs of the drive amplifier 32. Temperature sensors 40a, 40b, and 40c are thermally coupled to the housing 24, the spring member 20, and the tube 12. An output of the drive amplifier 32 is electrically coupled to the remaining transducer 30b. The drive amplifier 32 provides a signal, which excites the drive transducer 30b at or near the expected natural resonant frequency of the resonant structure of the meter 10. This natural resonant frequency is primarily determined by the tube 12, the spring element 20, the isolation members 22a and 22b, and the fluid within the tube 12. The tube resonant structure of the meter 10 responds to this excitation by vibrating. The sensing transducers 30a and 30c sense the motion of the tube and provide electrical signals corresponding to this motion to the drive amplifier 32. A connector (not shown) is disposed on the external housing 24 for coupling the transducers 30a, 30b, and 30c , the temperature sensors 40a, 40b, and 40c the pressure sensor 42 to inputs to the processor 38.

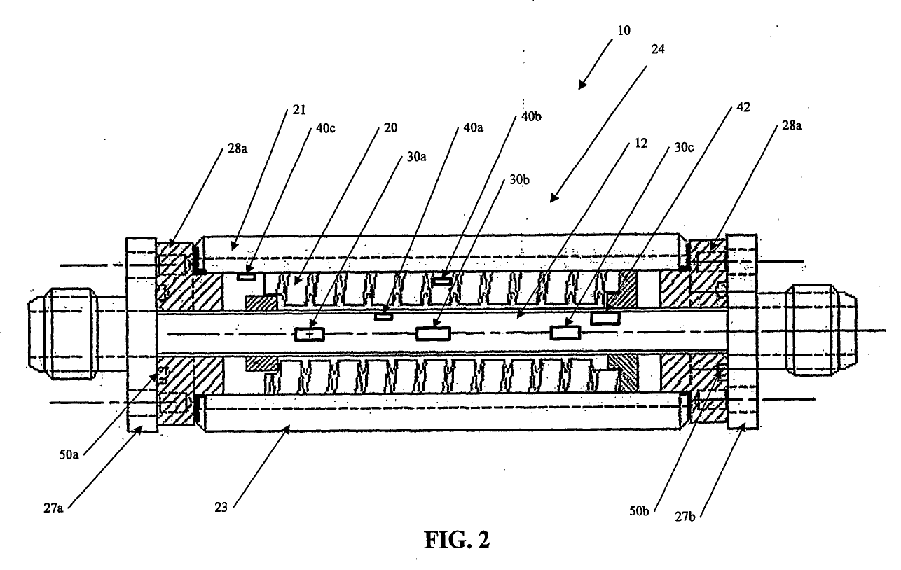

Another embodiment of the present invention is illustrated in FIG. 2. In this embodiment, the external housing 24 includes a top plate 21, a bottom plate 23, two side plates 25a and 25b, and the end caps 28a and 28b. These components of the housing 24 are fitted to form a rectangular box for housing the tube 12, the spring member 20, and the isolation members 22a and 22b. The tube 12, the spring member 20, and the isolation members 22a and 22b are rigidly coupled as described previously herein. The top plate 21 and the bottom plate 23 are fixed to the side plates 25a and 25b such that the top plate 23 is substantially parallel to the bottom plate 25a nd substantially perpendicular to the side plates 25a and 25b and end caps 28a and 28b. The tube 12 protrudes through the end caps 28a and 28b. The presently preferred method for rigidly coupling the top plate 21, the bottom plate 23, the two side plates 25a and 25b , and the end caps 28a and 28b is welding. It should be noted that in this embodiment, the end caps 28a and 28b do not provide fittings for coupling the assembly to external fluid devices. Fittings 27a and 27b are fixed to the end caps 28a and 28b and are shaped to provide for the fluid coupling of the tube 12 to external fluid devices. O-rings 50a and 50b are disposed between end caps 28a and 28b and fittings 27a and 27b to provide a fluid seal for the meter 10. The presently preferred method for rigidly coupling the end caps 28a and 28b to the fittings 27a and 27b is the use of screws (not shown). This method provides the flexibility of changing the fittings 27a and 27b to allow for different fluid coupling techniques easily and inexpensively. As in the embodiment of the invention shown in FIG. 1, the transducers 30a, 30b, and 30c are rigidly coupled to the tube 12, the temperature sensors 40a, 40b, and 40c are in thermal communication with the housing 24, the spring member 20, and the tube 12, and the pressure sensor 42 is in dynamic communication with the tube 12. The connector (not shown) is disposed on the top plate 21.

Referring once again to FIG. 1, the drive amplifier 32 compares the signals provided by the two sensing transducers 30a and 30c , and adjusts the frequency of the signal provided to the drive transducer 30b. A steady-state condition is reached when the frequency of the signal provided by the drive amplifier 32 to the drive transducer 30b is equal to the natural resonant frequency of the resonant structure of the meter 10. In the presence of this steady-state condition, the signals provided by the sensing transducers 30a and 30c to the drive amplifier 32 contain frequency, amplitude and relative phase information. As previously discussed herein, this information may be used to determine density, viscosity, and mass flow rate of the fluid within the tube 12.

In the presently preferred embodiments of the invention, the transducers 30a, 30b, and 30c are incorporated using piezoelectric ceramic devices commonly employed for this purpose. It should be noted that any of a variety of embodiments of the transducers 30a, 30b, and 30c , including electromagnets, could be implemented by one skilled in the art. The resonant structure of the meter 10, the transducers 30a, 30b, and 30c , and the drive amplifier 32 combine to form a phase locked loop (PLL) oscillator. PLL oscillators and their characteristics are well known, and one of ordinary skill in the art could envision a variety of embodiments of the drive amplifier 32 and the PLL oscillator.

An output signal of the drive amplifier 32 that is proportional to the signals provided by the sensing transducers 30a and 30c is electrically coupled to the input of the adaptive filter 34. The output signal of the adaptive filter 34 is electrically coupled to the input of the viscosity integrator 36. The signals provided by the adaptive filter 34 and the viscosity integrator 36 are made available to the processor 38.

The adaptive filter 34 implements a novel signal processing method that provides a signal to the processor 38 with substantially less noise and fewer spikes than are present in such signals in previous flow meters. These spikes and noise may result from interfering factory noise, entrained gas in the measured fluid, acoustically induced interference, external vibratory resonances or any of a variety of undesirable signal-corrupting influences.

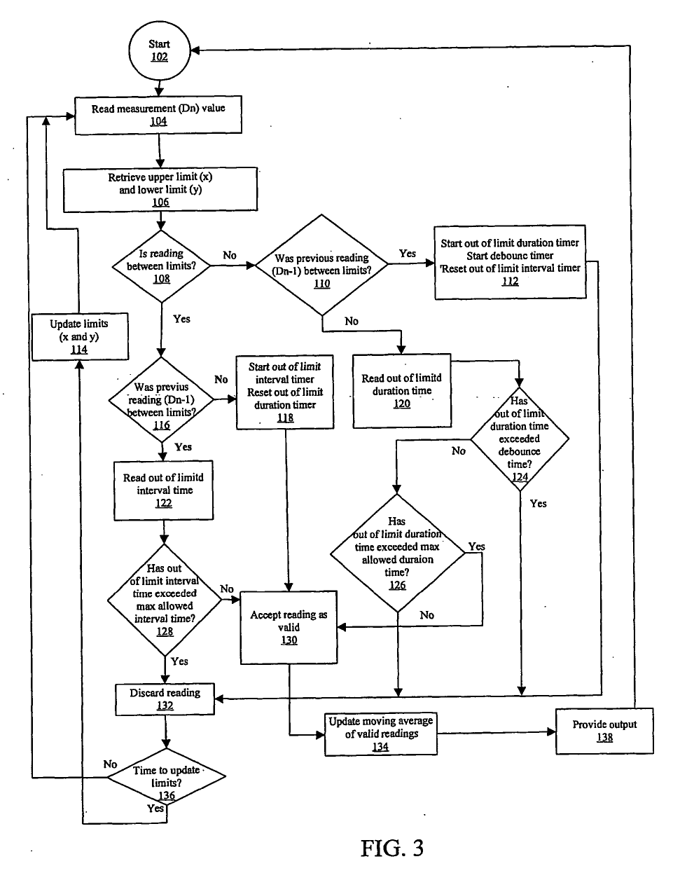

FIG. 3 shows a logical flow diagram for the process by which the adaptive filter 34 operates. The adaptive filter 34 samples the amplitude of one of the signals provided to it by the drive amplifier 32 and records the sampled measurement (step 104). The signal can be any of the variety of signals produced by the drive amplifier 32, which include the resonant frequency (which represents density), the amplitude of the phase shift (which represents mass flow rate), and the magnitude of the sensed signal (which represents fluid viscosity). It is important to note that the adaptive filter 34 may be used to filter any signal provided to it and would apply universally to any frequency, phase, or amplitude signal. The adaptive filter 34 retrieves a stored upper limit and a lower limit for the parameter being measured (step 106) and compares the sampled measurement to the retrieved upper and lower limits (step 108). These limits are initially set by the user but, as explained below, are adjusted as apart of the adaptive filtering process.

The adaptive filter 34 then measures the duration of time that the input signal has been outside the range between the upper limit and lower limit or within the range between the upper limit and lower limit. That is, the adaptive filter 34 determines the duration of time for which consecutive measurements have been between the upper limit and the lower limit, or above the upper limit or below the lower limit. To measure the duration of the aforementioned times, the adaptive filter 34 recalls the previous reading to determine if it was within or outside the limit range to see if a transition has occurred (steps 110, 116). It uses a transition from an out-of-limit reading to a between-limit reading (or vice versa) to start one timer and reset another. If the transition is from an out-of-limit reading to a within limit reading, then the filter 34 resets an out-of-limit duration timer and starts an out of range internal timer (step 118). Conversely, if the transition is from a within limit reading to an out-of-limit reading, then the filter 34 resets the out-of-limit interval timer and starts the out of range duration timer (step 112).

The user, as a part of the system initialization, provides three time limits to be used by the processor 38. The user sets the maximum allowable “spike” (out-of-limit reading) interval time, the maximum allowable “spike” duration time, and a time to denounce the reading of a spike. The filter 34 then reads the out-of-limit interval time 122 or the out-of-limit duration time (step 120) as appropriate and compares the out-of-limit interval time to the maximum allowable out-of-limit interval time (step 128) or compares the out-of-limit duration time to the maximum allowable out-of-limit duration time (step 124), respectively, as set by the user. The filter also compares the out-of-limit duration time to the denounce time (step 126), which is also user defined.

The filter 34 then defines the current measurement as valid or invalid by a series of logical decisions based on whether the signal is between the upper and lower limits and the duration of time for which this condition has been present. The present signal is determined to be valid 130 if the measurement of the signal is between the upper and the lower limits and this condition has been present for a time less than the maximum allowable “spike” interval time (step 128). The signal is also determined to be valid (step 130) if the signal is above the upper limit or below the lower limit and this condition has been present for a greater than maximum allowable “spike” duration time (step 126), and if the signal is above the upper limit or below the lower limit and this condition has been present for a time greater than the denounce time (step 124). The signal is determined to be invalid (step 132) if the signal is between the upper and the lower limits and this condition has been present for a time greater than the maximum allowable out-of-limit interval time (step 128). The present signal is also determined to be invalid if the signal is above the upper limit or below the lower limit and this condition has been present for a time less than the maximum allowable out-of-limit duration (step 126).

After the filter 34 determines that the present signal is valid, it uses the measurement to re-calculate a moving average for the subject signal (step) 134. First, an average measurement is calculated using:

$${D}_{navg} = {\sum }_{1}^{{C}_{av}} [ ( x - y ) / 2 + {D}_{n} ] / ( {D}_{n} + 1 )$$

Where
   x=the upper limit
   y=lower limit
   Dₙ=present reading
   C_{avg}=number of samples used to average reading

Periodically, a moving average of the average of the readings (D_{navg}) is calculated. This moving average is ρ_{avg}=(D_{navg1}+D_{navg2}+D_{navg3}+ . . . D_{navgm},)/m. This moving average is provided by the filter 34 for use by the processor 38 and the viscosity integrator 36 and represents reliable output information for the variable in question whether it is mass, mass flow rate and the like. In one preferred embodiment, ten samples are used to calculate each average (C_{navg}=10) and one hundred averages are used to calculate the moving average (m=100). Excellent results may be obtained, however, by adjusting the sample population size in accordance with specific measurement goals, as will be apparent to those skilled in the art.

The filter 34 discards or ignores any present measurement determined to be invalid and does not use it (step 132). The filter 34 then determines whether it is time to update the upper limit and the lower limit (step 136). The filter 34 dynamically updates the upper limit and the lower limit (step 114) periodically by adding and subtracting half the difference between the upper limit and the lowers limit to the most recent moving average value. The new limits used for subsequent filtering are:
x_{new}=(x−y)/2+ρ_{avg} and y_{new}=ρ_{avg}−(x−y)/2
These new limit values are updated for every ten valid measurements in the presently preferred method, but any suitable interval may be used.

The meter of the present invention can be used advantageously to measure fluid viscosity with accuracy. The amplitude of the sensor output is inversely proportional to the viscosity of the fluid within the tube. The amplitude of the sensor output signal is often distorted by outside disturbances. Thus, measurement of viscosity using a prior art vibrating tube flowmeter is reduced to measuring the half-power (3dB) amplitude and width of the corrupted sinusoidaly shaped sensor output signal. The energy of the signal (which is inversely proportional to the viscosity of the fluid) must therefore be calculated based on this first-order measurement, which is accurate only when the signal is virtually non-corrupted. In contrast, the adaptive filter of the present invention provides an uncorrupted signal to the viscosity integrator 36, which provides an opportunity to effectively determine the viscosity of the fluid with more accuracy than could be determined in meters of prior art. The viscosity of the fluid within the tube 12 is inversely proportional to the energy of the signal provided by the drive amplifier 32 and therefore, also inversely proportional to the energy of the signal provided by the adaptive filter 34. Any of a variety of methods for determining this energy content may be used to determine fluid viscosity, including a voltage follower, an envelope detector or an integrator, to name a few. The preferred embodiments of the present invention use a technique that is widely used in the field of chromatography, but has not heretofore been used with mass flow meters. This technique involves the use of a voltage follower, phase comparator, rectifier, and integrator network for detecting different type of gases in natural gas pipelines. This technique can be adapted to determine the energy of the signal provided by the drive amplifier 32. The viscosity integrator 36 buffers the sinusoidal output of the adaptive filter 32, phase locks the signal to a reference stored by the processor 38 as a part of the calibration process of the meter 10, rectifies the phase locked signal, and integrates the rectified signal. The result is compared to data stored by the processor 38 and determines the viscosity of the fluid by comparison and cross-correlation to the stored reference information.

Once again referring to FIG. 1, the temperature sensors 40a, 40b, and 40c are thermally coupled to the meter 10. Temperature sensor 40a is thermally coupled to the tube 12, thermal sensor 40b is thermally coupled to the spring element 20, and temperature sensor 40c is thermally coupled to the external housing 24. The temperature sensors 40a, 40b, and 40c are adapted to sense the temperatures of the tube 12, the spring element 20, and the external housing 24, respectively. The temperature sensors 40a, 40b, and 40c are each electrically coupled to the processor 38 to provide temperature information pertaining to the meter 10 and to the fluid within the meter. The temperature sensors 40a, 40b, and 40c utilized in the presently preferred embodiments of the invention are of the resistive temperature detector (RTD) type, but any temperature detection device envisioned by one of ordinary skill in the art might be employed.

Pressure sensor 42 is dynamically coupled to the tube 12. The pressure sensor 42 is adapted to sense the pressure of the fluid within the tube 12. The pressure sensor 42 is electrically coupled to the processor 38 to provide pressure information pertaining to the fluid within the meter 10. The presently preferred pressure sensor 42 is a strain gauge as is commonly used to detect force that is routinely used to measure pressure. It will be understood, however, and that this is but one of a variety of ways in which the pressure of the fluid within the tube 12 may be represented to the processor 38.

The processor 38 accepts signals from the adaptive filter 34, the viscosity integrator 36, the temperature sensors 40a, 40b, and 40c , the pressure sensor 42, and known fluid parameters provided as user inputs 46. The processor 38 measures or computes a variety of parameters related to the physical characteristics of the fluid within the tube 12. These fluid characteristics 44 are made available to the user of the meter 10 by the processor 38 by any of several means such as displaying the results to the user, storing the information in a database, or transmitting the information to a remote location, to name a few. The presently preferred embodiments of the invention provide information to the user including the fluid density, the fluid mass flow rate, the fluid volume flow rate, the fluid temperature, the fluid pressure, the fluid viscosity, and the percent concentration of the fluid by mass. The fluid temperature and fluid pressure are measured directly via the processor 38. Uncompensated measurements of the fluid density, the fluid mass flow rate, and the fluid viscosity are converted by the processor 38 and compensated for temperature and pressure.

A series of mathematical compensation algorithms is employed by the processor 38 to correct for temperature differences between components of the meter 10 and to improve the accuracy of the measurement. This is accomplished by adjusting the mass reading such that the mass is not only a function of the resultant natural resonant frequency of the resonant structure of the meter 10, but such that the mass is a function of the temperature due to the effects of temperature on the expected natural resonant frequency of the tube 12. That is, the difference between the natural resonant frequency of the resonant structure of the meter 10 at a specified temperature with a known fluid present in the tube 12 is calculated as a function not only of the mass of the fluid in the tube 12, but of the temperature characteristics of the meter 10. These temperature characteristics are measured under controlled calibration conditions and used to adjust the mass reading from the uncompensated mass reading, which ignores the effects of the temperature of the tube 12 and external housing 24.

According to a preferred embodiment of the invention, the uncompensated mass flow rate is calculated by the processor 38 using a method based on a modified version of a surface response type model solving three variables: density, tube temperature, and shell (external) temperature. The method uses the uncompensated density (D) of the measured fluid which is computed from:
D=C₀+C₁×(f⁻¹)×C₂(f⁻¹)²,
where C₀, C₁, and C₂ are coefficients determined during the meter calibration, and f is the frequency of oscillation provided by the drive amplifier.

The processor then may use any of three separate temperature compensation algorithms to compute the compensated density (Dt₁, Dt₂, or Dt₁₃). One temperature compensating algorithm available to the user is defined by.
Dt₁=(T₁×D+T₂)×(tₐ−t₀)+T₃×(tₐ−t₀)²,
where T₁, T₂, and T₃ are coefficients determined during the meter calibration, tₐ is the tube temperature as provided by the temperature sensor 40a coupled to the tube 12, and t₀ is the temperature at which the calibration of the meter was performed

A second algorithm utilizes the temperature of the external housing 24 as provided by temperature sensor 40c of the presently preferred embodiment. The second algorithm incorporates the result, Dt₁, of the first algorithm and is of the form:

$${Dt}_{2} = D + {C}_{5} + {C}_{6} ( {f}^{- 1} - {f}_{0}^{- 1} ) ( {t}_{h} - {t}_{0} ) + {C}_{7} ( {t}_{h} - {t}_{0} ) + {{C}_{8} ( {t}_{h} - {t}_{0} )}^{2} + {C}_{9} ( {t}_{a} - {t}_{0} ) + {{C}_{10} ( {t}_{a} - {t}_{0} )}^{2} + {{C}_{11} ( {t}_{a} - {t}_{0} )}^{3} + {C}_{12} ( {f}^{- 1} - {f}_{0}^{- 1} ) + {{C}_{13} ( {f}^{- 1} - {f}_{0}^{- 1} )}^{2} + {{C}_{14} ( {f}^{- 1} - {f}_{0}^{- 1} )}^{3} + {{C}_{15} ( {f}^{- 1} - {f}_{0}^{- 1} )}^{4} ,$$

where C₅ through C₁₅ are determined during the meter calibration and tₕ is the external housing temperature.

Another algorithm for temperature compensated density utilizes the results of the other two algorithms and is:
Dt₃=Dt₂+C₁₆(Dt₂−D)+C₁₇(Dt₂−D)²+C₁₈(Dt₂−D)³,
where C₁₆ through C₁₈ are determined during the meter calibration.

The foregoing temperature compensating method for determining density produces results over a wider range of temperatures than have methods implemented in previous flow meters. By implementing this method, the present invention provides a novel approach in the calculation of the effects of temperature on fluid density measurement.

Similarly, the difference between the natural resonant frequency of the resonant structure of the meter 10 at a specified fluid pressure with a known fluid present in the tube 12 is calculated as a function not only of the mass of the fluid in the tube 12, but of the fluid pressure characteristics of the meter 10. These pressure characteristics are measured under controlled calibration conditions and used to adjust the density reading from the uncompensated density reading, which ignores the effects of temperature. Three algorithms for determining pressure-compensated fluid density are utilized by the presently preferred embodiment of the invention. These algorithms use the results of the algorithms that provide temperature-compensated density readings previously discussed herein.

One algorithm implemented by the processor 38 to calculate the pressure-compensated fluid density is:
DP₁=Dt₁+(P₁×D+P₂)×(Pₐ−P₀)+P₃×(Pₐ−P₀)²,
where P₁, P₂, P₃ are coefficients determined during the meter calibration. Pₐ is the pressure reported by pressure sensor 42 to the processor 38, P₀ is the pressure at which the calibration of the meter 10 was performed.

A further refined calculation for the pressure-compensated fluid density is:
DP₂=Dt₂+(P₁×D+P₂)×(Pₐ−P₀)+P₃×(Pₐ−P₀)².

A third algorithm for pressure is:
DP₃=Dt₃+(P₁×D+P₂)×(Pₐ−P₀)+P₃×(Pₐ−P₀)².

As will be apparent to one of ordinary skill in the art, calculations similar to the foregoing calculations for determining temperature and pressure compensated density also can be used to calculate the compensated mass flow rate and viscosity.

The fluid volume flow rate is calculated by the processor 38 as the fluid mass flow rate divided by the fluid density. The percent concentration of the fluid by mass is algorithmically computed by the processor 38 utilizing the measured fluid density, the measured temperature of the fluid, the measured pressure of the fluid and known volume and pre-defined density information of the dissolved substance as provided by the-user.

The processor 38 can determine the concentration of a fluid solution by accepting and processing the multitude of readings provided to it by the meter 10, the filter 34, the viscosity integrator 36 as well as the temperature sensors 41a, 40b, and 40c, and the pressure sensor 42. Uncompensated readings for concentration level, as well as temperature and pressure compensated readings, are computed by the processor 38. The user inputs to the processor 38 density and volume data for the specific components that make up the solution. The processor 38 then calculates the concentration ratio using the density measurements from the meter 10. The uncompensated concentration ratio is computed using:

$$Concentration ratio = \frac{{V}_{sn} \times {ρ}_{sn}}{( {V}_{w} + {V}_{s 1} + {V}_{s 2} + {V}_{sn} ) \times {ρ}_{0}} \times CF$$

where Vₛₙ is the volume of solute n as provided by the user, ρₛₙ is the density of solute n as provided by the user, V_{w} is the volume of water or any other base fluid of the solution as provided by the user, ρ_{w} is the density of water or base fluid as provided by the user, ρ₀ is the uncompensated density as calculated by the processor 38, and CF is a correction factor for measurement nonlinearities and is empirically determined during meter calibration.

A temperature compensated calculation of the concentration ratio is calculated using:

$$Concentration ratio = \frac{{V}_{sn} \times ( {ρ}_{sn} \times CT \times Δ t )}{( {V}_{w} + {V}_{s 1} + {V}_{s 2} + {V}_{sn} ) \times ( {ρ}_{0} \times CT \times Δ t )} \times CF$$

where CT is the specific temperature coefficient for the base fluid. This coefficient is obtained from reference materials as known in the art. Δt is the difference in the temperature of the fluid from the temperature at which the density of the base fluid was provided.

A pressure compensated calculation of the concentration ratio is calculated using:

$$Concentration ratio = \frac{{V}_{sn} \times ( {ρ}_{sn} \times CT \times Δ t ) \times ( CP \times Δ P )}{\begin{matrix}( {V}_{w} + {V}_{s 1} + {V}_{s 2} + {V}_{sn} ) \times \\ ( {ρ}_{0} \times CT \times Δ t \times CP \times Δ P )\end{matrix}} \times CF$$

where CP is the specific pressure coefficient for the base fluid. This coefficient is obtained from reference materials as known in the art. ΔP is the difference in the pressure of the fluid from the pressure at which the density of the base fluid was provided. The pressure and temperature of the fluid are provided to the processor 38 by the use of the pressure sensor 42 and the tube temperature sensor 40a.

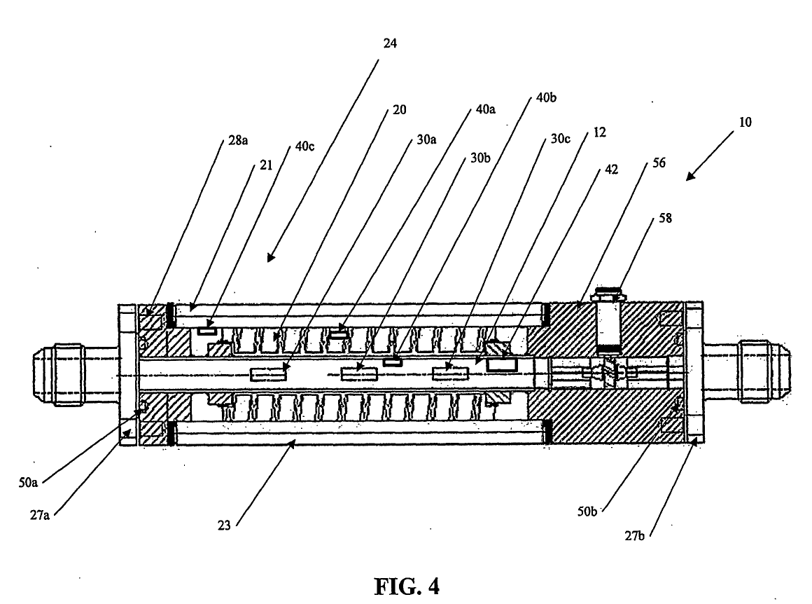

In some applications where the frequency of external vibration spectra are of sufficient amplitude, the Coriolis effect forces are insufficient to produce detectable phase changes relative to the fluid zero flow condition. These conditions are present in aircraft, particularly during take-off and landing conditions and render a Coriolis-effect meter ineffective in measuring mass flow rate due to the meter's typical low operating frequency. FIG. 4 illustrates a composite mass flow meter 54 according to the present invention, which can be used for such an application. The composite flow meter 54 utilizes the structure of the preferred embodiment of the mass flow meter 10 depicted in FIG. 2. The second end cap 28b is replaced with a volume flow meter 56. The volume flow meter 56 is rigidly coupled to the top plate 21, the bottom plate 23, and the two side plates such that the tube 12 is in fluid communication with the volume flow meter 56. One of the fittings 27b is then rigidly coupled to the volume flow meter 56 to provide fluid combination between the volume flow meter 56 and external fluid devices. The O-ring 50b is dispose between the volume flow meter 56 and the fitting 27b to provide a fluid seal. The volume flow meter 56 includes a volume flow indicator 58, which provides a reading of the volume flow of the fluid within the tube 12. The volume flow indicator 58 is in communication with the processor 38 of the present invention. The volume flow meter 56 may be of any of a variety of types of volume flow meters well known in the art including, but not limited to turbine meters, vortex meters, ultrasonic meters, orifice meters and thermal meters.

The positioning of the volume flow meter 56 adjacent the tube 12 provides a measure of volume flow of the fluid in the tube 12 such that a more accurate measurement of flow rate can be obtained. The accuracy reducing effects of connectors, non-laminar flow into the volume flow meter 56 and pressure loss in connecting lines, just to mention few are avoided in this configuration. The volume flow information provided to the processor by the volume flow indicator enables the processor to calculate the mass flow rate with relative ease and great accuracy. The mass flow rate is the volume flow rate multiplied by the density of the fluid, the density of the fluid being proportional to the resonant frequency of the resonant structure as previously explained herein.

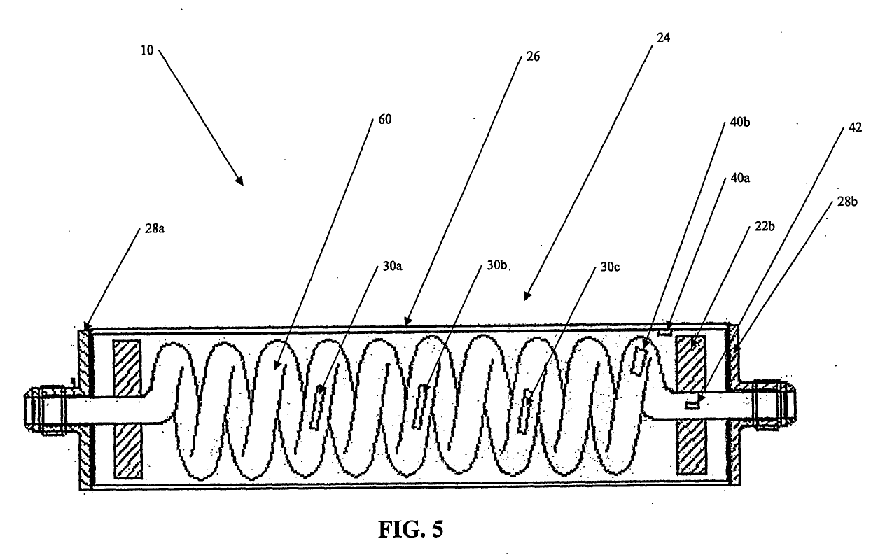

FIG. 5 depicts an alternate embodiment of a mass flow meter according to the-present invention. This structure is similar to the first embodiment of the straight tube flow meter 10 discussed above, except that a coiled tube 60 is used to transport the fluid and is the predominant resonance-determining device. The coiled tube 60 is rigidly coupled to the isolation members 22a and 22b. The tube 60 and the isolation members 22a and 22b are enclosed in the external housing 24 and are placed in fluid communication with external devices by way of end caps 28a and 28b. As in the previously described meters, the transducers 30a, 30b, and 30c are rigidly coupled to the tube 60, the temperature sensors 40a, and 40b are in thermal communication with the housing 24 and the tube 60, and the pressure sensor 42 is in dynamic communication with the tube 60. The connector 48 is disposed on the housing 24. This embodiment of a mass flow meter provides a novel configuration by which the fluid length of the tube 60 is significantly greater then the length of the housing 24, which is a critical design requirement for a Coriolis mass flow transducer. This results in a significant reduction in space as compared to mass flow meters of prior art, which is advantageous in a variety of applications including the aerospace industry.

From the foregoing, it can be seen that the present invention provides a number of advantages. A flow meter according to the invention, can accurately measure mass flow over a wide range of operating temperatures. It can reduce the undesirable effects of localized heating of the flow tube during the assembly process and provide mass flowmeters that are accurate despite changes in pressure of the fluid within the tube. The flow meter can operate with great accuracy in the presence of undesirable acoustic and similarly generated interference and can operate with great accuracy when the fluid within the flowmeter contains entrained gases. It can utilize a signal processing technique that filters unwanted noise from the measured signal within the flowmeter. This method can provide for improved accuracy of direct mass flow, density, and viscosity. The multivariable mass flowmeter according to the invention can accurately and instantaneously provide measurements including but not limited to fluid density, flow rate, mass flow rate, temperature, pressure, concentration, and viscosity. A composite mass flow meter according to the invention can provide directly measure mass flow in harsh environments, such as aircraft flight, particularly during take-off and landing scenarios. A coiled tube flow meter according to the invention can provide a space saving embodiment for aerospace applications.

While certain preferred embodiments and methods of the invention have been described, these have been presented by way of example only, and are not intended to limit the scope of the present invention. Additional advantages and modifications will readily occur to those skilled in the art. Therefore, the invention in its broader aspects is not limited to the specific embodiments, methods and conditions described herein, which are not meant to and should not be construed to limit the scope of the invention. Accordingly, departures may be made from such embodiments and methods, variations may be made from such conditions, and deviations may be made from the details described herein without departing from the spirit or scope of the general inventive concept as defined by the appended claims and their equivalents.

What is claimed is:

1. A vibrating-tube meter for measuring the density, mass flow rate or viscosity of a fluid material, the meter comprising:
a hollow tube having an inlet end and an outlet end and including a vibration section;
excitation means for inducing vibrations in the tube vibration section at a resonance frequency;
motion sensing means for detecting motion of the tube from the induced vibrations; and
a spring element coupled to the vibration section between a first end and a second end of the vibration section.

2. The vibrating tube meter according to claim 1 wherein the spring element comprises a helical coil spring having opposing ends coupled to the tube.

3. The vibrating tube meter according to claim 1 wherein the at least a portion of the tube is positioned within the interior of the coil spring.

4. The vibrating tube meter according to claim 1 wherein the vibration section of the tube is generally aligned along a tube longitudinal axis and the spring element comprises a helical coil spring having a longitudinal axis oriented generally along the tube longitudinal axis.

5. The vibrating tube meter according to claim 1 wherein the vibration section of the tube is generally straight.

6. The vibrating tube meter according to claim 1 further comprising an external housing rigidly coupled to the tube inlet end and outlet end and having a mass selected to provide a suitable nodal mass for the tube vibration section and spring element.

7. The vibrating tube meter according to claim 1 wherein the spring element is selected to have a spring load constant to isolate the vibration section from vibrations external to the vibration section and spring.

8. The vibrating tube meter according to claim 1 wherein:
the tube vibration section includes a first isolation member attached to the tube near one end of the vibration section and a second isolation member attached to the tube near another end of the vibration section;
the spring element first end is attached to the first isolation member; and
the spring element second end is attached to the second isolation member.

9. The vibrating tube meter according to claim 8 wherein the first and second isolation members are brazed to the tube, the spring element first end is welded to the first isolation member and the spring second end is welded to the second isolation member.

10. The vibrating tube meter according to claim 1, wherein the tube vibration section has a coefficient of thermal expansion and the spring element is composed of a material selected to have a coefficient of thermal expansion that generally matches the coefficient of thermal expansion of the tube vibration section.

11. The vibrating tube meter according to claim 1, wherein the tube vibration section and the spring element are composed of matching material.

12. The vibrating tube meter according to claim 1, wherein the spring element comprises a steel or titanium.

13. The vibrating tube meter according to claim 1, wherein the tube includes a curved portion.

14. A tube assembly for a densitometer or mass flow meter or viscometer of the vibrating-tube type, the assembly comprising:
a hollow tube having a first isolation member coupled near an inlet end and a second isolation member coupled near an outlet end;
an excitation device coupled to the tube;
one or more motion sensing devices coupled to the tube; and
a spring element coupled to the tube between the first and second internal isolation members.

15. The tube assembly according to claim 14 wherein the spring element comprises a helical coil spring having opposing ends coupled to the isolation members.

16. The tube assembly according to claim 14 wherein the tube includes a section that is generally straight.

17. The tube assembly according to claim 14 wherein the tube includes a section that is generally curved.

18. The tube assembly according to claim 14 wherein the spring element is rigidly attached to the isolation members and the isolation members are rigidly attached to the tube.

19. The tube assembly according to claim 14 wherein each of the isolation members comprises a flange disposed around the tube.

20. The tube assembly according to claim 14 wherein the isolation members are brazed to the tube and the spring element first is welded to the isolation members.

21. The-tube assembly according to claim 14, wherein the tube has a coefficient of thermal expansion and the spring element is selected to have a coefficient of thermal expansion that generally matches the coefficient of thermal expansion of the tube.

22. The tube assembly of claim 14 farther comprising a temperature sensor coupled to the tube to sense the temperature of the tube.

23. The tube assembly of claim 14 further comprising a temperature sensor coupled to the spring element to sense the temperature of the spring element.

24. The tube assembly of claim 14 further comprising a pressure sensor coupled to the tube to sense the pressure of fluid material in the tube.

25. The vibrating tube meter according to claim 6 further comprising a temperature sensor coupled to the external housing element to sense the temperature of the external housing.

26. A method for manufacturing a vibrating tube densitometer or mass flow meter or viscometer, the method comprising:
providing a hollow tube having an isolation member near an input end and an isolation member near an output end;
coupling one or more excitation devices to the tube;
coupling one or more motion sensing devices to the tube; and
coupling a spring element to the tube between the internal isolation members.

27. The method according to claim 26 wherein the step of coupling the spring element to the tube comprises brazing the isolation members to the tube and welding the spring element to the isolation members.

28. The method according to claim 26 wherein the step of coupling one or more excitation devices to the tube comprises attaching a piezoelectric transducer to the tube.

29. The method according to claim 26 wherein the step of coupling one or more motion sensing devices to the tube comprises attaching a piezoelectric transducer to the tube.
